(19) United States
(12) Patent Application Publication
(10) Pub. No.: US 2026/0278056 A1
(43) Pub. Date: Sep. 17, 2026

(54) SECURED CHARGER DEVICE

(71) Applicant: 66 PROTECT PTY LTD, Mornington (AU)

(72) Inventor: Steve POLLOCK, Safety Beach (AU)

(21) Appl. No.: 19/566,060

(22) Filed: Mar. 13, 2026

(30) Foreign Application Priority Data
Mar. 13, 2025 (AU) 2025900788

(51) Int. Cl. G06F 21/32; G06F 21/86

(52) U.S. Cl. CPC G06F 21/32; G06F 21/86

(57) ABSTRACT

A charger device configured to supply charging power to an external electronic device is disclosed. The device includes a housing supporting at least one electrical connection outlet, an isolation circuit disposed between an input power source and the outlet, a fingerprint sensor, and a controller programmed to authenticate fingerprint data captured by the sensor against stored fingerprint data and, only upon successful authentication, enable the isolation circuit to allow electrical power to be supplied to the outlet. In some embodiments, the device may further include status indicators, a user input element, a retractable charging cable, and a mains plug receivable in a slot. Optional features can include tamper detection, location tracking, and control of inward and/or outward power flow subject to biometric authorization.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to personal devices secured via fingerprint authentication.

### 2. Description of Related Art Including Information Disclosed Under 37 CFR 1.97 and 37 CFR 1.98.

Users of smart technologies typically have multiple personal devices, such as a laptop, tablet, smartphone, e-reader, headphones, etc. A recurring issue is recharging such devices in a reliable manner and discouraging theft of such devices. It is desirable to secure such devices to discourage theft or tampering.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

In one aspect, the invention provides a charger device configured to supply charging power to an external electronic device, the charger device comprising:

a housing supporting at least one electrical connection outlet;

an isolation circuit disposed between an input power source and the at least one electrical connection outlet, the isolation circuit being switchable between an enabled state that allows electrical power to be supplied from the input power source to the at least one electrical connection outlet and a disabled state that prevents electrical power from being supplied;

a fingerprint sensor configured to capture fingerprint data of a user; and

a controller operatively coupled to the fingerprint sensor and the isolation circuit, the controller being programmed to:

authenticate a fingerprint captured by the fingerprint sensor against stored fingerprint data; and

switch the isolation circuit to the enabled state only upon successful authentication, and otherwise maintain the isolation circuit in the disabled state.

In one embodiment, the fingerprint scanner comprises a pressure‑sensitive fingerprint sensing unit configured to initiate a scan in response to applied pressure.

In another embodiment, the at least one electrical connection outlet comprises at least one USB‑type outlet selected from USB‑A, USB‑C, USB‑B, Micro‑USB, or Thunderbolt.

In another embodiment, the charger device further comprises a pivotable cable‑retention clamp mounted to the housing and lockable thereto, the clamp defining a slot sized to pass charging cables while blocking removal of cable connectors.

In another embodiment, the controller is configured to unlock the clamp in response to authenticating an authorized fingerprint via the fingerprint scanner.

In another embodiment, the charger device further comprises a retractable charging cable and a cable‑retraction locking mechanism, wherein the controller is configured to unlock the cable‑retraction locking mechanism only upon successful fingerprint authentication.

In another embodiment, the charger device further comprises at least one tamper‑detection sensor configured to trigger deletion of stored fingerprint credentials and to disable the isolation circuit in response to detecting a tamper condition.

In another embodiment, the charger device further comprises a tracking module configured to determine a location of the charger device and provide location information to an external system.

In another embodiment, the charger device further comprises an auxiliary battery configured to supply independent operating power to the tracking module.

In another embodiment, the charger device further comprises an integrated mains power plug configured to connect the charger device to a mains power point.

In another embodiment, the charger device further comprises an internal rechargeable battery, wherein the charger device is configured to operate as a portable power bank when disconnected from an external power source.

In another embodiment, at least one electrical connection outlet is configured as a dual‑function port operable both to supply charging power to an external electronic device and to receive charging power to recharge the internal rechargeable battery.

In another embodiment, the controller is programmed to enable the dual‑function port to operate as a charging inlet only upon successful fingerprint authentication.

In another embodiment, the housing defines a slot configured to receive a removable mains power plug that is replaceable with alternative power plug formats.

In another embodiment, the charger device further comprises a plug‑locking mechanism configured to secure the mains plug within the slot and to release the mains plug only upon successful fingerprint authentication via the fingerprint scanner.

In another aspect, the invention provides a method of controlling power delivery of a charger device, the method comprising:

receiving, at a fingerprint sensor mounted to a housing of the charger device, fingerprint data of a user;

processing, by a controller operatively coupled to the fingerprint sensor, the fingerprint data to determine whether the fingerprint data matches stored fingerprint data of at least one authorized user;

in response to determining that the fingerprint data matches the stored fingerprint data,

switching, by the controller, an isolation circuit disposed between an input power source and at least one electrical connection port of the charger device from a disabled state that prevents electrical power from reaching the at least one electrical connection port to an enabled state that supplies electrical power to the at least one electrical connection port; and

in response to determining that the fingerprint data does not match the stored fingerprint data,

maintaining, by the controller, the isolation circuit in the disabled state.

In another embodiment, the method further comprises, after a predetermined time interval or upon detecting cable removal from the at least one electrical connection port, switching the isolation circuit back to the disabled stat

According to another aspect, the present invention provides a charger device having at least one connection outlet for charging electronic equipment, the charger device comprising an isolation means for preventing electrical power from being supplied to the connection outlet(s).

Preferably, the charger device comprises a control means for controlling the isolation means, wherein the control means can actuate the isolation means to allow or disallow supply of electrical power to the connection outlet.

Preferably, the charger device comprises a fingerprint scanner for scanning and sending fingerprint data to the control means.

Preferably, the connection outlets comprise USB connection outlets.

Preferably, the fingerprint scanner is a pressure sensitive sensor to detect when a finger is being pressed onto the scanner.

Preferably, the isolation means comprises an isolator switch which is electronically linked to the fingerprint scanner to electronically effect locking and unlocking of the charger.

Preferably, the charger device comprises a logic control means in communication with the fingerprint scanner and the isolation means, wherein the logic control means supervises the validation of user fingerprints against a memory store of enrolled fingerprints and if authorized, commands the isolation means to unlock the charger.

Preferably, the charger device comprises a pivotable clamp mounted to the body, the clamp including a central slot which is sized to allow cables to pass through but not the USB connection points of such cables.

Preferably, the clamp can be unlocked from the charger body via the fingerprint scanner.

In one embodiment, the charger is for connection to a mains power point.

In another embodiment, the charger is a portable charger (powerbank).

In another embodiment, the charger device further includes a retractable charger cable having a retraction mechanism which is unlocked via fingerprint authorization.

In another embodiment, the charger device further includes a tamper sensor for triggering fingerprint credential wipe and hard power shut off.

In another embodiment, the body includes a slot configured to receive a removable mains plug, wherein the mains plug is detachable from the slot and replaceable with alternative plug formats.

In another embodiment, the slot includes a locking mechanism configured to secure the mains plug within the slot.

In another embodiment, the locking mechanism is configured to release the mains plug upon authentication of a fingerprint via the fingerprint scanner.

In the powerbank embodiment, recharging of the portable charger is enabled only after a valid fingerprint is authenticated by the fingerprint scanner, such that the control means prevents electrical power from being supplied to an internal charging circuit until an authorised fingerprint is verified.

In this embodiment, at least one of the connection outlets is preferably configured to operate as a charging inlet for recharging the portable charger, and wherein the control means selectively enables the charging inlet only upon successful authentication of an authorised fingerprint.

In another preferred embodiment, the fingerprint authentication requirement applies both to activation of the connection outlet(s) for charging external devices and to activation of the USB charging inlet for recharging the portable charger, thereby preventing unauthorised charging or use of the device

In another aspect, the invention provides a consumer item having an isolation means for preventing electrical power from being supplied to the consumer item, a control means for controlling the isolation means, wherein the control means can actuate the isolation means to allow or disallow supply of electrical power to the connection outlet, and a fingerprint scanner for scanning and sending fingerprint data to the control means.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows a perspective view of a charger according to a preferred embodiment of the present invention.

FIG. 2 shows a perspective view of the charger with a cable clamp.

FIG. 3 is a flowchart showing how the charger works in an example use.

FIG. 4 shows a perspective view of another embodiment of the charger.

FIG. 5 shows a perspective view of a biometric‑secured wireless earbuds with fingerprint‑controlled pairing and charging.

FIG. 6 shows a perspective view of a biometric‑secured power tool battery with fingerprint‑activated power and GPS tracking.

FIG. 7 shows five various perspective views of a biometric‑secured device charger according to another embodiment.

FIG. 8 shows a perspective view of a biometric‑secured device charger according to another embodiment.

### DETAILED DESCRIPTION OF THE INVENTION

It should be noted in the following description that like or the same reference numerals in different embodiments denote the same or similar features.

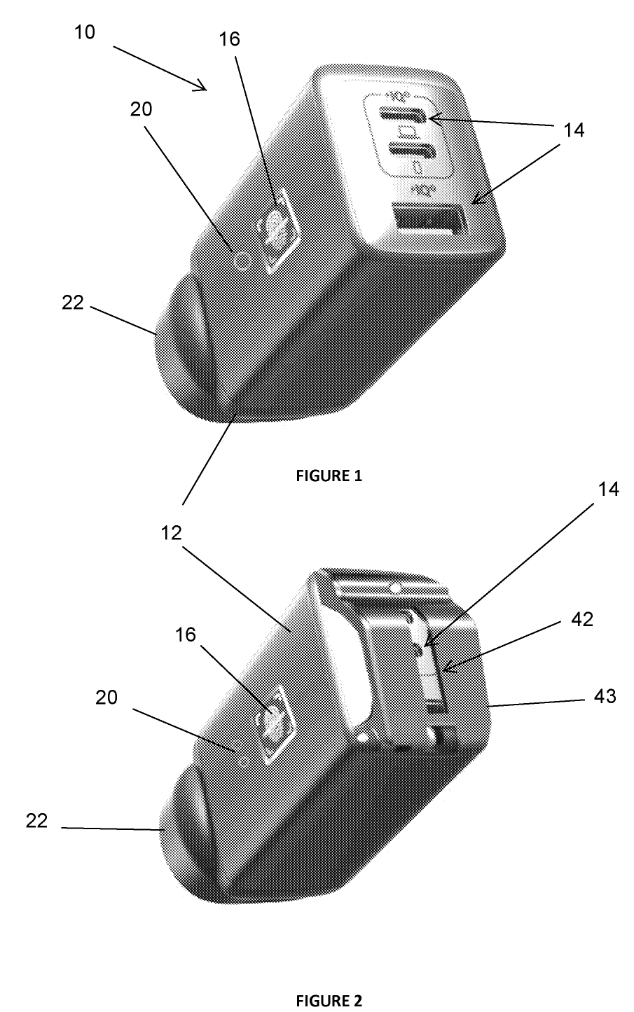

FIG. 1 shows a biometric fingerprint locked device charger 10 according to a preferred embodiment of the present invention. The charger 10 comprises a body 12 having USB connection outlets 14 at a rear surface thereof. The USB connection outlets 14 include USB-A and USB-C outlets. It is to be understood that other types of outlets 14 can be also be used such as USB-B, Micro USB, Thunderbolt, etc.

A biometric fingerprint scanner 16 is mounted to the side wall of the charger 10. The fingerprint scanner 16 can be a pressure sensitive sensor configured to detect when a finger is being pressed onto the scanner 16. An isolation means comprising an isolator switch is electronically linked to the fingerprint scanner 16 to electronically effect locking and unlocking of the charger 10. When locked, no electrical power is supplied to the connection outlets 14. When unlocked, electrical power is supplied to the connection outlets 14.

A logic control means is secured within the body of the charger 10 and in communication with the fingerprint scanner 16 and the isolation means. The logic control means supervises the validation of user fingerprints against a memory store of enrolled (authorized) fingerprints and if authorized, commands the isolation means to unlock the charger 10.

The default state of the charger 10 is the Locked state. The user can unlock the charger 10 by pressing an authorized fingerprint to the fingerprint scanner 16 at which the charger will move to the Unlocked state, where power will be supplied to the outlets 14. The charger 10 will automatically move back to the Locked state under predetermined or desired conditions, such as after a predetermined nominated charging time (e.g. 90 minutes), upon removal of the charger 10 from a mains power point, removal of any cables from the outlets 14, disruption of any charging process such as disconnection of a device being charged, or the user pressing an authorized fingerprint to the fingerprint scanner 16 to effect locking of the charger 10.

In its factory default setting, any finger scanned will unlock the charger 10. To start adding fingerprints, the user will hold their finger to the fingerprint scanner 16 for 5 seconds until the LED indicator 20 changes (the first fingerprint will be the Admin User for operating the device). The user will then press and release a finger multiple times (5-10) to program a new print. The LED indicator 20 will signal once the reading of the print is complete (green).

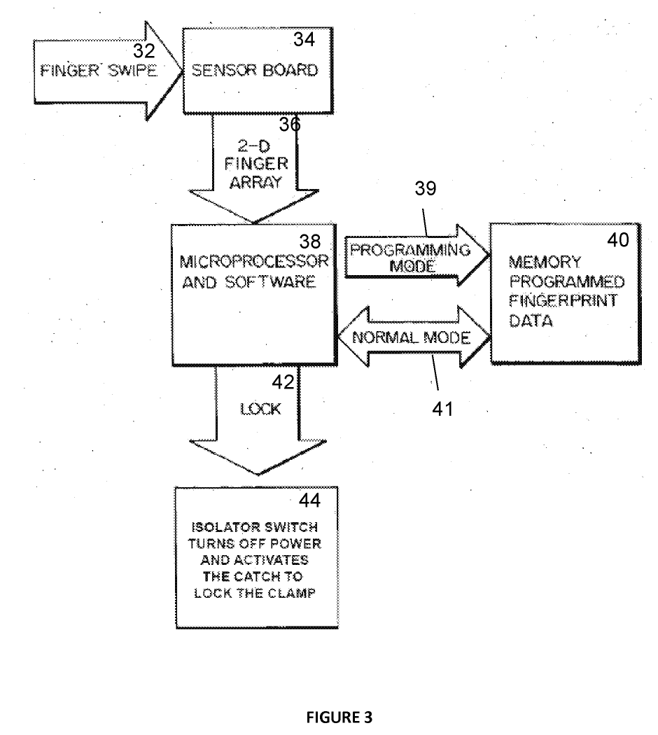

The steps in adding a fingerprint and storing them into memory of the charger 10 are shown in FIG. 3. The sequence begins at block 32 when a user presses a thumb against the fingerprint scanner 16. At block 34, the control means initiates a fingerprint scan via a sensor board. After the scan, at block 36, features of the fingerprint image are extracted and sent to a CPU running a software (block 38) effecting the control means. The fingerprint features are sent (block 39) to a memory unit 40.

To add more fingerprints, using the Admin fingerprint, the user presses on the fingerprint scanner 16 for 5 seconds. Once the LED Indicator 20 starts flashing BLUE, the user will then press and release the new fingerprint to be read 5-10 times until programming is completed (the LED will flash GREEN).

Performing a Factory Reset - To factory reset the charger, and remove all stored fingerprints, the user will press and hold the Admin User’s fingerprint for 20 seconds until the RED indicator lights stays on then release and the fingerprint scanner 16 will read the Admin User’s print one more time to reset.

In an alternative embodiment, the fingerprint scanner 16 is pressure sensitive which informs the logic and control means that an object is pressed against the fingerprint scanner 16, initiating a print scan.

In another alternative embodiment, the charger 10 can be connected to a computer or smartphone for example via Bluetooth or USB connection. The computer or smartphone can operate a software application (app) which allows the user to enrol and store authorized fingerprints to the charger 10.

FIG. 3 also shows the steps of an unlock sequence for authenticating a user fingerprint at block 32 and unlocking the charger 10. At block 34, the control means initiates a fingerprint scan via the sensor board. After the scan, at block 36, features of the fingerprint image are extracted and sent to the CPU 38. The features are compared (block 41) against enrolled users in the memory 40 and if the fingerprint does not match an enrolled print, then the procedure exits and the charger 10 remains locked. The LED indicator 20 can blink red to confirm the unauthorized attempt. If the fingerprint matches that of an enrolled print, then control transfers to block 42 where the CPU 38 commands the isolation means (isolator switch) to electronically unlock the lock.

FIG. 2 shows an additional feature, being a pivotable clamp 43 mounted to the body 12. The clamp 43 includes a central slot 42 which is sized to allow cables to pass through but not the USB connection points of such cables. When USB cables are inserted into the outlets 14, the pivotable clamp 43 can prevent removal of such cables from the charger 10. The clamp 43 is mechanically locked to the charger body. The clamp 43 can be moved to a pivoted away unlocked position also using the fingerprint scanner 16 – the scanner and control means unlocking the clamp from the body. Alternatively or additionally, the charger 10 can also include a retractable charger cable, where the retraction mechanism can only be unlocked via fingerprint authorization.

The charger 10 thus also has a locking mechanism 43 for the cord, where upon activation, a locking mechanism will release the clamp that secures the charging cord.

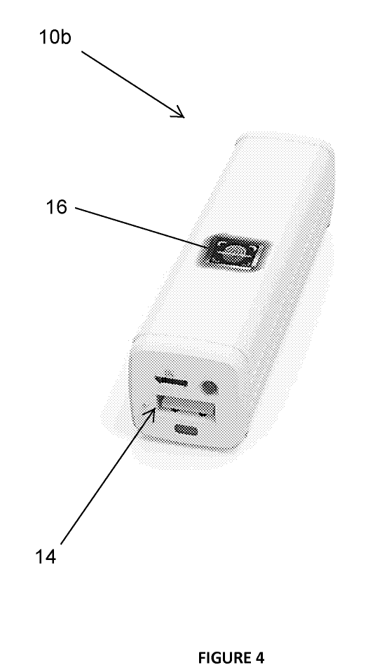

The charger 10 shown is for connection to a mains power point via plug end 22. It is to be understood that the charger 10 can also be a portable charger (powerbank) such as the charger 10b shown in FIG. 4. The charger 10b for example can be charged via one of the ports 14. The charger 10 or 10b can include additional features such as a charging tracker for finding the charger when lost, and a phone tracker - for pinging a phone via the charger with a sound.

In an alternative embodiment, the charger can be actuated via a password, code or combination functionality instead of Fingerprint authentication.

The invention addresses the problem of loss of chargers for devices such as phones, laptops, etc resulting in continued purchase of replacement chargers. The invention individualizes a charger device rendering it useless to other individuals unless specifically assigned to them. This stops theft of chargers, ensures users are able to maintain the correct voltage for their device, and prevents theft of charging cables. The invention also allows parents to control when children’s devices can be charged and thus monitor control of devices and device usage.

The invention has been expanded into other Biometric-Secured devices with optional GPS Tracking

The invention relates to an anti-theft and anti-tampering system that integrates biometric authentication and optional GPS tracking. This technology is applicable to phone chargers, wireless earbuds, power tool batteries, and other electronic devices that require secure charging mechanisms. The invention provides a novel solution to prevent unauthorized access, deter theft, and enable location tracking in case of loss or misplacement.

The present invention provides a biometric-secured item (charger/device/personal item) that is accessible only to authorized users through fingerprint authentication. The item is embedded with a fingerprint scanner that activates or deactivates the power supply based on authentication. Additionally, a GPS tracking system is incorporated to enable real-time tracking of the item in case of theft or misplacement.

The biometric-secured item comprises several key components designed to enhance security and prevent unauthorized use. The first component is a fingerprint scanner that authenticates the user before enabling the item. The first fingerprint registered on the device is designated as the Admin User, who can later add additional users. Unless an authorized fingerprint is scanned, the item remains inactive, preventing unauthorized access.

Another feature is that in addition to biometric security, the charger can be embedded with a GPS tracking module that enables real-time location tracking. Users can monitor their item’s location via a mobile application, making it easier to recover in case of theft or loss.

The invention can be expanded to other devices. The inventor specializes in advanced anti-theft and anti-tampering security solutions, integrating biometric fingerprint authentication with GPS tracking technology. The proprietary system ensures that only authorized users can access or operate protected devices, preventing unauthorized use, theft, or tampering. Below is a detailed description of product applications and their functionalities:

### 1. Biometric-Secured Phone Charger 10

The fingerprint-protected phone charger is designed to restrict unauthorized usage and deter theft. The charger features an integrated biometric scanner that deactivates power output when removed from the power source. Upon reconnection, the charger remains inactive until an authorized user authenticates via the fingerprint scanner. Additionally, an embedded GPS tracking module allows real-time location monitoring in case of theft.

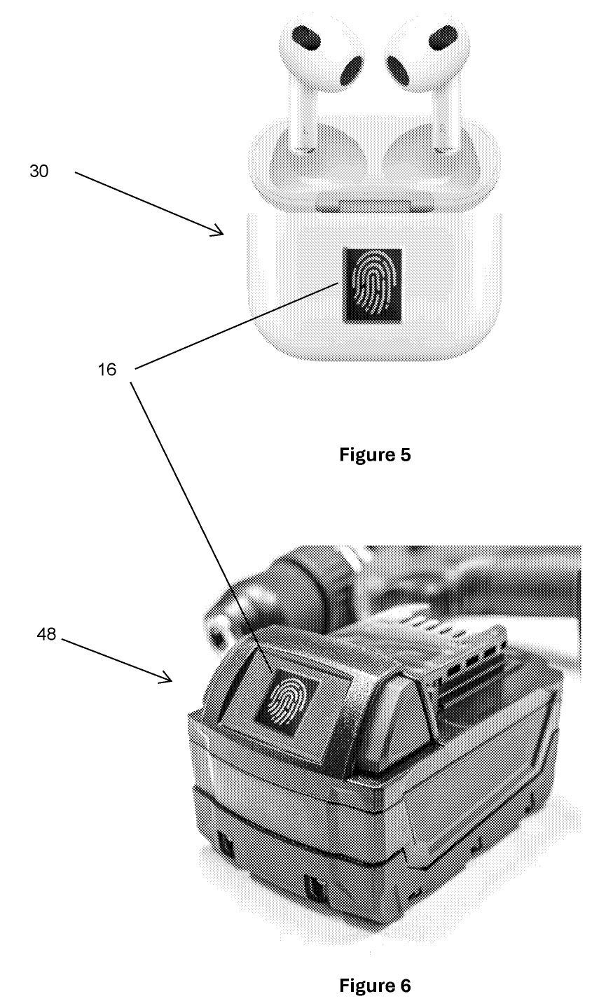

### 2. Biometric-Secured Wireless Earbuds 30 (FIG. 5)

This security-enhanced earbud system employs fingerprint authentication to prevent unauthorized pairing and charging. The power supply to the earbuds remains deactivated unless an approved user authenticates via the fingerprint scanner 16. Furthermore, an integrated GPS tracking device enables location tracking in the event of loss or theft.

This security-enhanced wireless earbud system is designed to prevent unauthorized access and ensure user-specific operation through biometric authentication. The system employs a fingerprint scanner (16), which is integrated into the charging case or earbud body. Authentication is required before the earbuds can be paired with a device or powered on, ensuring that only approved users can utilize them.

The power supply to the earbuds remains deactivated by default, preventing unauthorized users from charging or using the device. Only after successful biometric verification will the system allow power flow, reducing the risk of theft and unauthorized usage. Additionally, the earbuds are equipped with an integrated GPS tracking device, enabling real-time location tracking. This feature allows owners to locate their earbuds in case of misplacement or theft. The tracking system can be linked to a mobile app, providing alerts and location updates to the registered owner.

Other security enhancements may include tamper detection mechanisms to prevent bypassing the authentication system, multi-user authentication options allowing multiple approved users to register their fingerprints, and automatic deactivation if the earbuds are taken out of the authorized range without proper authentication.

### 3. Biometric-Secured Power Tool Batteries 48 (FIG. 6)

The innovative battery protection system integrates fingerprint authentication 16 to control power activation. Unauthorized users cannot charge or utilize the battery without biometric verification. Embedded GPS tracking further enhances security by allowing owners to monitor the battery’s location remotely in case of theft.

This advanced battery security system integrates fingerprint authentication (16) to regulate power activation and prevent unauthorized usage. The system is specifically designed for power tools and industrial applications, ensuring that only verified users can operate or charge the battery.

Key security features include restricted power activation, where the battery remains in a locked state unless an authorized fingerprint is scanned, preventing unauthorized personnel from using high-powered tools and enhancing workplace safety. The system also includes anti-theft charging protection, ensuring that unauthorized users cannot charge the battery, reducing the risk of stolen batteries being repurposed or sold. Furthermore, an embedded GPS tracking system allows remote monitoring of the battery’s location in case of loss or theft. This feature integrates with a companion mobile app or cloud platform, enabling real-time location tracking and alerts.

Additional features may include user activity logs that store authentication records to track who accessed and used the battery, multi-user access control allowing supervisors to authorize multiple workers while maintaining security, and a tamper-resistant casing that prevents physical bypassing of the authentication system.

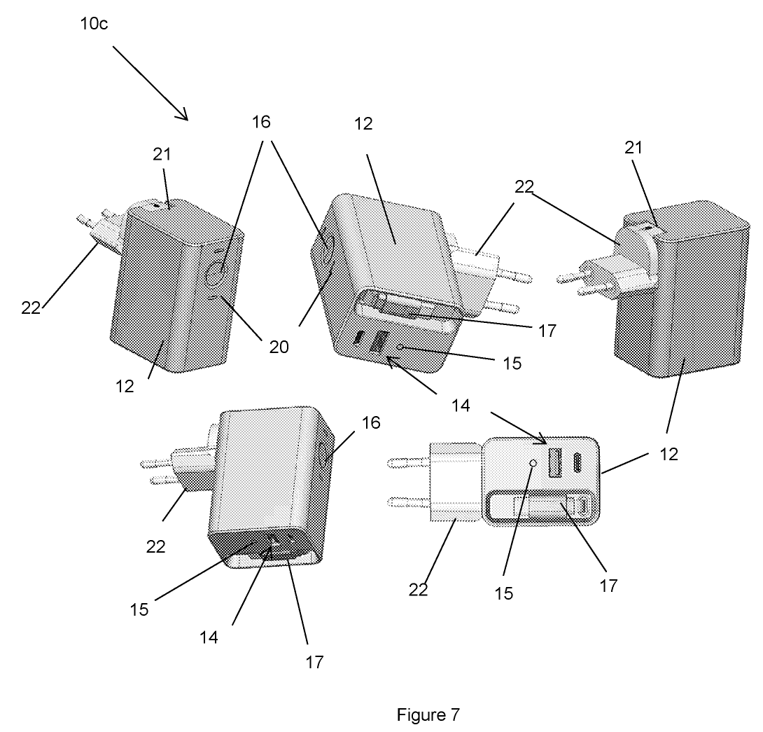

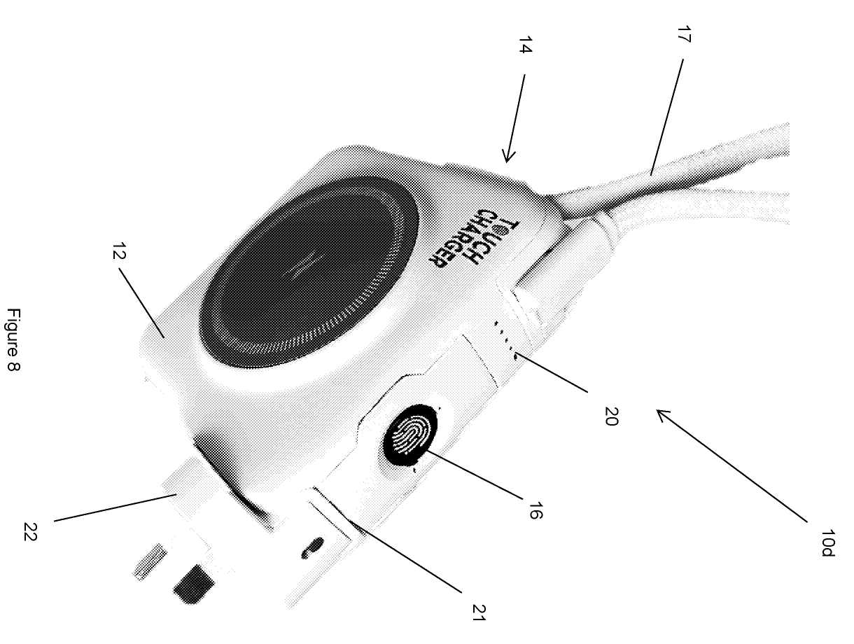

FIG. 7 illustrates a further embodiment of a biometric fingerprint‑locked device charger 10c. The charger 10c similarly includes a body 12 supporting a set of USB connection outlets 14 at a lower surface thereof.

Mounted on a front wall of the body 12 is the fingerprint scanner 16, which may be implemented as a pressure‑sensitive sensing unit. Adjacent to the fingerprint scanner 16, the charger 10c further includes LED indicators 20 visible externally from the body 12 for providing visual feedback regarding device status.

In this embodiment, the charger 10c additionally includes a button 15 positioned on the housing, the button 15 being configured for user interaction such as initiating a reset function or placing the device into a fingerprint scan/enrolment mode.

The charger 10c is further provided with a retractable USB‑C cable 17, stored within the body 12 and extendable through an opening for connection to external electronic devices. The cable 17 is able to retract into the body 12 when not in use.

A further feature of the charger 10c is that the mains plug 22 is removable and replaceable. The rear portion of the body 12 defines a slot 21 configured to receive the plug 22. This arrangement enables the plug 22 to be detached and replaced with alternative plug formats suitable for use in different countries, ideal for travel use. The slot 21 may incorporate a locking mechanism that secures the plug 22 within the slot 21 until released via the fingerprint scanner 16.

The locking mechanism may take various forms, such as a mechanical latch, spring biased detent, or an electronic lock. The removable plug 22 may include electrical contact prongs that mate with internal terminals within the slot 21, and the slot 21 may be positioned on a rear portion of the body 12. The plug 22 may engage the slot 21 by sliding, snap fit, or other releasable engagement structures.

The device can additionally include one or more tamper sensors triggering credential wipe and hard power shut‑off.

FIG. 8 illustrates a biometric‑secured device charger 10d according to another embodiment of the invention. The charger 10d is structurally similar to the charger 10c described above and includes the same functional features unless otherwise specified. In particular, the charger 10d includes a body 12 supporting a set of USB connection outlets 14, and a fingerprint scanner 16 mounted on a top surface of the body for biometric authentication. LED indicators 20 are provided adjacent the fingerprint scanner 16 to display operational states of the device. The charger 10d can further includes a user‑operable button for initiating functions such as device reset or entry into fingerprint enrolment mode. As with the earlier embodiment, the charger 10d incorporates a retractable USB‑C cable 17 stowed within the body 12 and extendable for charging external devices, and a removable mains plug 22 receivable in a slot 21 formed at the rear of the body 12. The mains plug 22 may be secured within the slot 21 by a locking mechanism that is configured to release only upon successful fingerprint authentication via the fingerprint scanner 16. It is to be understood that the charger 10d may further include any of the features previously described in relation to chargers 10, 10b and 10c, including tamper detection, an auxiliary tracking battery, tracking device, and biometric‑controlled activation of inward and outward power flow.

In the preferred embodiment, the combination of biometric locking, a permanently built‑in tracking module, and retractable, non‑removable charging cords ensures complete anti‑theft coverage. The charger cannot be used without authorised fingerprint authentication, cannot be hidden due to its constant locatability, and cannot be stripped for parts since the cables are integrated and lockable. Together, these features create a unified security system that protects both the device and its accessories from all common theft scenarios. The tracker in the preferred embodiment is always built in.

In the portable charger (powerbank) embodiment, recharging of the internal battery of the device is restricted by the fingerprint‑based authentication system. In this configuration, the portable charger remains incapable of receiving charging current until a valid fingerprint has been authenticated by the fingerprint scanner. The fingerprint scanner supplies fingerprint data to the control means, which validates the fingerprint against a memory store of authorised fingerprints. Only after successful authentication does the control means permit operation of the internal isolation means, thereby enabling electrical power to be supplied to the internal charging circuit. Until such authentication occurs, the control means maintains the isolation means in a state that prevents any electrical energy from reaching the internal battery, effectively preventing unauthorised recharging of the device.

In this embodiment, at least one of the connection outlets is further configured to function as a charging inlet for the purpose of recharging the portable charger. Preferably, a USB connection outlet is dual‑configured to act as both an output for supplying charging power to external devices and an inlet for receiving charging power from an external power supply. The control means supervises activation of this charging inlet and selectively enables it only after a valid fingerprint has been authenticated. Accordingly, the device prevents electrical power received via the charging inlet from being routed to the internal charging circuitry unless the user has been authenticated through the fingerprint scanner, thereby ensuring that both recharging and usage of the device remain restricted to authorised individuals.

In another preferred embodiment, the fingerprint authentication requirement applies comprehensively to both outward and inward power transfer functions of the device. Specifically, the control means is configured such that activation of the connection outlet(s) for supplying charging power to external electronic equipment, as well as activation of the USB charging inlet for recharging the internal battery of the portable charger, each require successful fingerprint authentication prior to operation. This dual‑control arrangement ensures that no power can be drawn from or supplied to the device without proper authorisation. As a result, the portable charger is protected against unauthorised charging, unauthorised use, and misuse in a range of potential theft or tampering scenarios.

In yet another embodiment, the plug‑in version of the charger may also be configured to operate as a portable power bank while incorporating the same security and control features described above. In this configuration, the plug‑in charger includes an internal rechargeable battery and the associated control means, fingerprint authentication system, and isolation means required to manage both power input and output. This allows the plug‑in charger to function not only as a mains‑powered charging device but also as a standalone portable power bank when disconnected from an external power source. The fingerprint‑based authentication system continues to regulate activation of the connection outlets and recharging of the internal battery, ensuring that the enhanced anti‑theft and user‑authorisation features remain applicable in both plugged‑in and portable operational modes.

In one implementation, the isolation means may be realised as an electronic MOSFET‑based high‑side power switch configured to interrupt the positive supply line to the connection outlet(s). In another implementation, the isolation means may include a relay, solid‑state relay, transistor array, or dedicated USB power‑gating IC. These components are electrically connected between the incoming power source and the connection outlet(s), and the control means actuates the isolation means by providing a control signal to enable or disable current flow.

The control means and logic control means may be implemented using a microcontroller unit (MCU) such as an ARM Cortex‑M processor, RISC‑V microcontroller, or equivalent embedded controller. The MCU executes firmware that receives fingerprint image data, performs template matching using stored fingerprint templates in non‑volatile memory, determines authentication state, and outputs control signals to the isolation means, locking mechanisms, retractable cable motor, or GPS module.

The fingerprint scanner may be an optical, capacitive, ultrasonic, or pressure‑sensitive fingerprint sensor module. In one example embodiment, the scanner comprises a sensing array that captures a fingerprint image and a local processing Application-Specific Integrated Circuit (ASIC) that extracts characteristic minutiae data before sending the resulting template to the control means for comparison against stored templates.”

The GPS tracking module may include a GNSS receiver chip, an LTE‑M, NB‑IoT, LoRa, or Bluetooth Low Energy (BLE) communication module, and an integrated antenna. The module may periodically transmit the device’s location to a cloud server or paired smartphone application. Power to the tracking module may be managed by the control means and may include a low‑power sleep state, periodic wake cycles, or continuous tracking depending on configuration.

The tamper sensor may be implemented using one or more of: a mechanical microswitch, accelerometer, gyroscope, Hall sensor, strain gauge, enclosure‑open sensor, or conductive mesh. Detection of tampering causes the control means to erase stored fingerprint templates from non‑volatile memory and to disable the isolation means, thereby shutting off all power output.

Where a USB port is configured to operate as both a charging output and charging input, the port may include a USB Power Delivery (USB‑PD) controller IC or equivalent circuit capable of negotiating power directionality. The control means may override negotiation results unless a valid fingerprint has been authenticated, thereby preventing power from flowing into or out of the device.

In embodiments including a mobile application, the app may communicate with the device via Bluetooth, Wi‑Fi, or USB. The app may permit fingerprint enrollment, location monitoring, tamper alerts, firmware updates, or log review. Communication protocols may include encrypted message formats, secure transport layers, and authenticated pairing procedures.

The retractable cable may be driven by a spring‑loaded reel or miniature electric motor. The control means may actuate an electromagnetic latch or electronically controlled pawl to permit or prevent retraction. Upon successful fingerprint authentication, the latch is released, allowing the cable to be extended or withdrawn.

The charger device can comprise an internal rechargeable battery and being configured to operate selectively as a plug‑in charger (with a power point plug) when connected to a mains power point and as a portable power bank when disconnected from the mains power point, while maintaining fingerprint‑gated control of power input and output.

In a further embodiment, the tracking module is powered by a dedicated, smaller rechargeable battery housed within the device body. This auxiliary battery remains electrically isolated from the main charging circuitry and is configured to maintain continuous or periodic operation of the tracker even when the primary charger functions are disabled or when the main internal battery is depleted. The auxiliary battery may be recharged automatically whenever the device is connected to an external power source, and the control means may supervise charging of the auxiliary battery to ensure uninterrupted tracking capability.

The preferred embodiment of the invention integrates a fingerprint sensor locking mechanism with a Bluetooth tracking system and built-in retractable charging cords within a single charging device. This combined configuration provides a comprehensive anti-theft solution addressing multiple potential points of theft, loss, or unauthorised use.

The fingerprint sensor locking mechanism restricts operation of the charger to authorised users only, thereby preventing unauthorised access or use of the device. The integrated Bluetooth tracker enables the charger to be located through a compatible tracking network if the device is misplaced or stolen. The Bluetooth tracking module operates using an internal rechargeable battery, allowing the tracking functionality to remain active independently of the charger’s primary power source.\

In addition, the charger incorporates retractable charging cords housed within the device enclosure, reducing the risk of cable removal, tampering, or theft.

Through the integration of biometric authentication, location tracking capability powered by an internal rechargeable battery, and physically secured retractable cables, the invention provides a multi-layered security system designed to protect both the charging device and its associated components from theft, loss, or unauthorised use.

I claim:

1. A charger device configured to supply charging power to an external electronic device, the charger device comprising:
a housing supporting at least one electrical connection outlet;
an isolation circuit disposed between an input power source and the at least one electrical connection outlet, the isolation circuit being switchable between an enabled state that allows electrical power to be supplied from the input power source to the at least one electrical connection outlet and a disabled state that prevents electrical power from being supplied;
a fingerprint sensor configured to capture fingerprint data of a user; and
a controller operatively coupled to the fingerprint sensor and the isolation circuit, the controller being programmed to:
authenticate a fingerprint captured by the fingerprint sensor against stored fingerprint data; and
switch the isolation circuit to the enabled state only upon successful authentication, and otherwise maintain the isolation circuit in the disabled state.

2. The charger device of claim 1, wherein the fingerprint scanner comprises a pressure‑sensitive fingerprint sensing unit configured to initiate a scan in response to applied pressure.

3. The charger device of claim 1, wherein the at least one electrical connection outlet comprises at least one USB‑type outlet selected from USB‑A, USB‑C, USB‑B, Micro‑USB, or Thunderbolt.

4. The charger device of claim 1, further comprising a pivotable cable‑retention clamp mounted to the housing and lockable thereto, the clamp defining a slot sized to pass charging cables while blocking removal of cable connectors.

5. The charger device of claim 4, wherein the controller is configured to unlock the clamp in response to authenticating an authorized fingerprint via the fingerprint scanner.

6. The charger device of claim 1, further comprising a retractable charging cable and a cable‑retraction locking mechanism, wherein the controller is configured to unlock the cable‑retraction locking mechanism only upon successful fingerprint authentication.

7. The charger device of claim 1, further comprising at least one tamper‑detection sensor configured to trigger deletion of stored fingerprint credentials and to disable the isolation circuit in response to detecting a tamper condition.

8. The charger device of claim 1, further comprising a tracking module configured to determine a location of the charger device and provide location information to an external system.

9. The charger device of claim 8, further comprising an auxiliary battery configured to supply independent operating power to the tracking module.

10. The charger device of claim 1, further comprising an integrated mains power plug configured to connect the charger device to a mains power point.

11. The charger device of claim 1, further comprising an internal rechargeable battery, wherein the charger device is configured to operate as a portable power bank when disconnected from an external power source.

12. The charger device of claim 11, wherein at least one electrical connection outlet is configured as a dual‑function port operable both to supply charging power to an external electronic device and to receive charging power to recharge the internal rechargeable battery.

13. The charger device of claim 12, wherein the controller is programmed to enable the dual‑function port to operate as a charging inlet only upon successful fingerprint authentication.

14. The charger device of claim 1, wherein the housing defines a slot configured to receive a removable mains power plug that is replaceable with alternative power plug formats.

15. The charger device of claim 14, further comprising a plug‑locking mechanism configured to secure the mains plug within the slot and to release the mains plug only upon successful fingerprint authentication via the fingerprint scanner.

16. A method of controlling power delivery of a charger device, the method comprising:
receiving, at a fingerprint sensor mounted to a housing of the charger device, fingerprint data of a user;
processing, by a controller operatively coupled to the fingerprint sensor, the fingerprint data to determine whether the fingerprint data matches stored fingerprint data of at least one authorized user;
in response to determining that the fingerprint data matches the stored fingerprint data,
switching, by the controller, an isolation circuit disposed between an input power source and at least one electrical connection port of the charger device from a disabled state that prevents electrical power from reaching the at least one electrical connection port to an enabled state that supplies electrical power to the at least one electrical connection port; and
in response to determining that the fingerprint data does not match the stored fingerprint data,
maintaining, by the controller, the isolation circuit in the disabled state.

17. The method of claim 16, further comprising, after a predetermined time interval or upon detecting cable removal from the at least one electrical connection port, switching the isolation circuit back to the disabled state.
